(19) United States
(12) Patent Application Publication
(10) Pub. No.: US 2018/0299033 A1
(43) Pub. Date: Oct. 18, 2018

(54) BI-DIRECTIONAL CABLE GUIDE

(71) Applicant: Brian S. Feiner, St. Louis, MO (US)

(72) Inventor: Brian S. Feiner, St. Louis, MO (US)

(21) Appl. No.: 15/918,056

(22) Filed: Mar. 12, 2018

Related U.S. Application Data
(63) Continuation-in-part of application No. 13/205,188, filed on Aug. 8, 2011, now abandoned.

(51) Int. Cl. F16L 5/00; F16L 3/12

(52) U.S. Cl. CPC F16L 5/00; F16L 3/1222

(57) ABSTRACT

A cabling and wire guiding device including a structural member defining a first surface and a second, oppositely spaced and generally parallel second surface, a generally toroidal aperture extending through the structural member and having a first end intersecting the first surface and an oppositely disposed second end intersecting the second surface, and first and second rounded end portions connecting the respective ends to the respective surfaces. An elongated cylindrical workpiece extends through the aperture. The elongated cylindrical workpiece may freely move back and forth through the aperture. The aperture remains unsealed to the workpiece, wherein the aperture is at least slightly ovoid. Fluid flow though the aperture is maintained and uninterrupted by the elongated cylindrical workpiece.

### CROSS-REFERENCE TO RELATED APPLICATIONS

This patent application is a continuation-in-part of co-pending U.S. patent application Ser. No. 13/205,188, filed on Aug. 8, 2011, and claims priority thereto.

### TECHNICAL FIELD

This novel technology relates to the field of construction, and, more particularly, to a method and apparatus for the cabling of structures.

### BACKGROUND

Electrical cable and wiring is typically covered in a protective sheath. While the protective sheath protects the cable or wiring, the sheath can prove troublesome when wiring and cabling a structure. Cabling is the threading of a cable or wire though apertures formed through supportive members within a structure. As a cable or wire is advanced through an aperture, the protective sheath can snag or provide significant resistance to being threaded or pulled through the aperture within the supportive member. This is especially true if the cable is pulled back in the reverse direction, since apertures are designed to guide cabling in the forward direction and have sharp edges on the exit side which are designed to engage sheathing to prevent the cable from being pulled through in the reverse direction; this has the undesired side-effect of stripping and damaging the underlying cable if the cable is urged back in the opposite direction. The added resistance greatly increases the burden upon the workman performing the cabling. Further, as noted above, this resistance may result in the protective sheath being ripped or damaged and/or the cable or wire itself being damaged, especially when the cable is pulled in reverse. Often this damage remains undetected until after the structure is finished, requiring expensive and time-consuming repair work. Additionally, after a cable or wire is cabled, it is beneficial to be able to lock the cable or wire in place to prevent further movement and potential damage. Thus, there is a need for a structural building member with preformed apertures providing enhanced cabling attributes and for an improved method of stringing cable. The present invention addresses these needs.

### BRIEF DESCRIPTION OF THE DRAWINGS

FIG. 1A is a first partial perspective view of a cabling and wire guiding structural building member having bi-directional cable guide apertures formed therethrough.

FIG. 1B is a top plan cutaway view of the cabling and wire guiding structural building member of FIG. 1.

FIG. 1C is a top plan cutaway view of the cabling guide structural member of FIG. 1 with raised rounded aperture ends.

FIG. 2A is a top plan cutaway view of the cabling and wire guiding structural building member of FIG. 1.

FIG. 2B is a partial plan view of the cabling and wire guiding structural building member of FIG. 1.

FIG. 3 is a second partial plan view of the cabling and wire guiding structural building member of FIG. 1.

FIG. 4 is a partial perspective view of the cabling and wire guiding structural building member of FIG. 1 as attached to another building member.

### DETAILED DESCRIPTION

For the purposes of promoting an understanding of the principles of a novel technology, reference will now be made to the embodiments illustrated in the drawings and specific language will be used to describe the same. It will nevertheless be understood that no limitation of the scope of the novel technology is thereby intended, such alterations and further modifications in the illustrated device, and such further applications of the principles of the novel technology as illustrated therein being contemplated as would normally occur to one skilled in the art to which the novel technology relates.

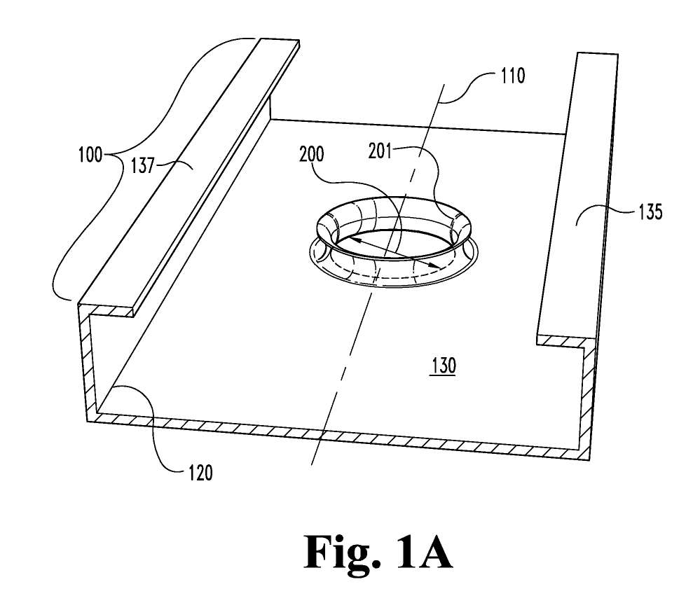

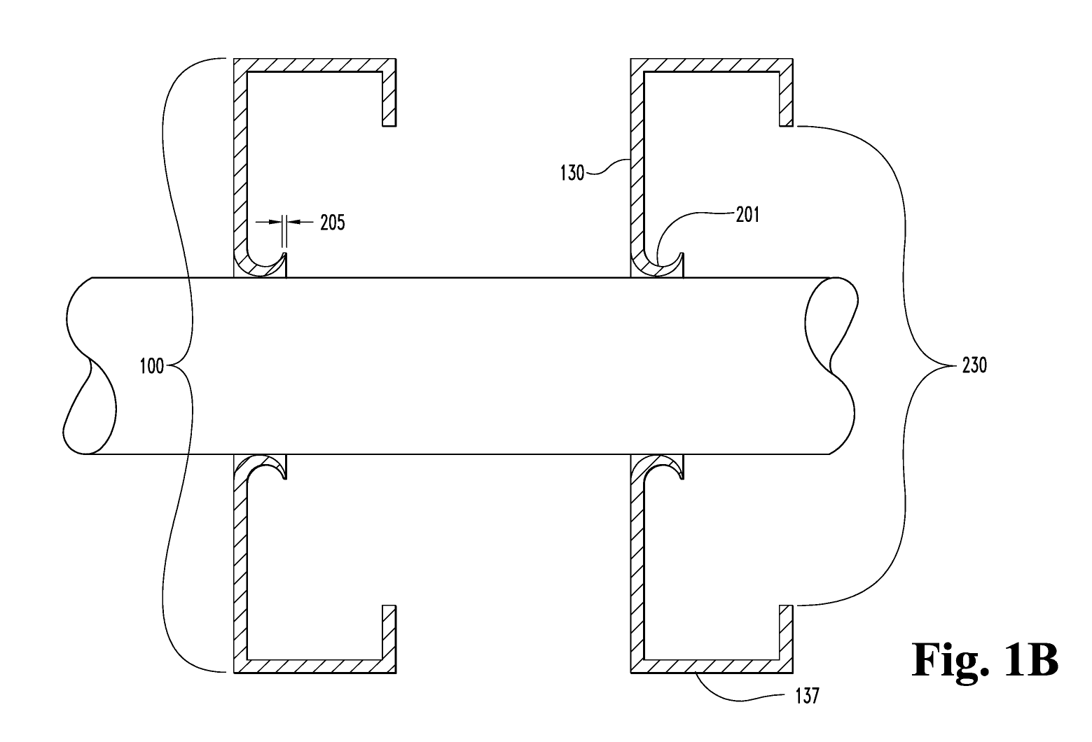

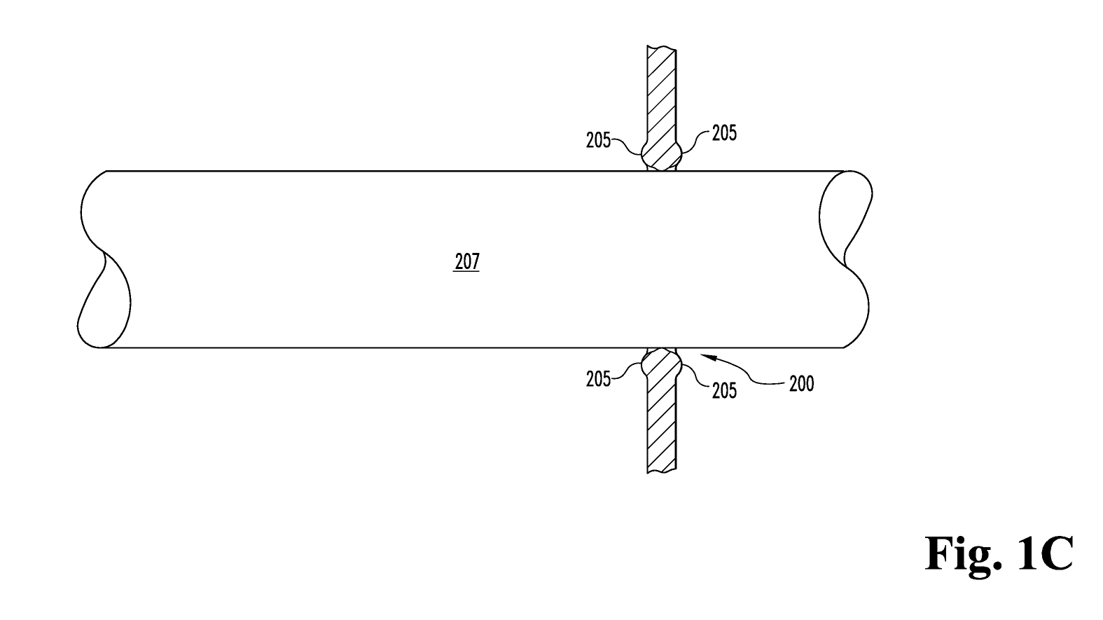

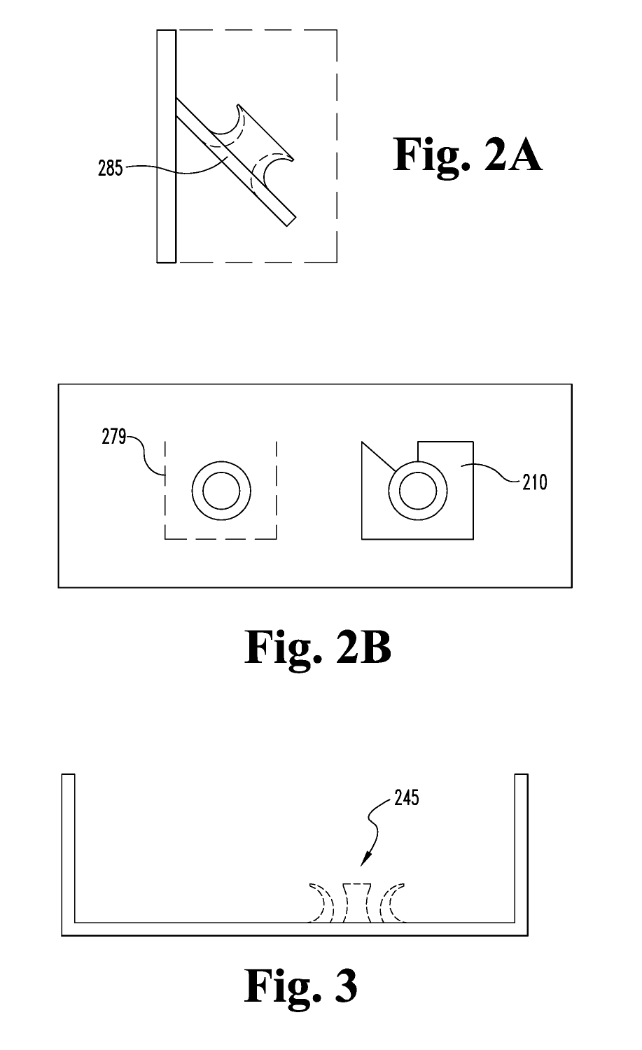

FIGS. 1A-4 illustrate the first embodiment of the present novel technology, a cabling and wire guiding structural building member 100. The cabling and wire guiding structural member 100 is typically made of a structural material, such as sheet metal, steel, composites, wood or the like. The cabling and wire guiding structural building member 100 typically has a substantially flat or planar surface 130 extending along a longitudinal axis 110. The cabling and wire guiding structural building member 100 typically has at least one second surface 135 intersecting the substantially flat surface 130. The intersection 120 of the at least one second surface 135 and the substantially flat surface 130 is typically parallel to the longitudinal axis 110. In some implementations, the at least one second surface 135 and the substantially flat surface 130 intersect to define a perpendicular angle. In other implementations, either the substantially flat surface 130 and/or the at least one second surface 135 may include attachment points 230 such as nubs, clips, or the like to assist in the attaching of the cabling and wire guiding structural building member 100 to another structural member.

The member further includes a third surface 137 opposite first surface 130 and connected thereto by aperture 200 extending therethrough. Aperture 200 includes a hollow hyperboloid shape resembling the interior structure of a toroid 201 positioned in and through member 100 and terminating in rolled or rounded terminus portions 205 at either end, with one rolled terminus portion extending through first surface 130 and another, opposite rolled or rounded terminus portion 205 extending between the second surface 135 and the third surface 137. The aperture 200 has a mostly circular shape. However, some implementations utilize different shapes for the aperture 200. Examples of other shapes for the aperture 200 include an octagon, a mostly oval shape, a rounded triangle shape, and the like.

In some implementations, the cabling and wire guiding structural building member 100 is shaped to facilitate the joining of two building members. For example, the cabling and wire guiding structural building member 100 may be shaped to facilitate the joining of a floor joist to a support wall or a rafter to a support wall, or the like. In some implementations, the second surface 135 is formed such that the second surface 135 can mechanically attach to another structural or building member. For example, the second surface 135 may be shaped in a cabling and wire guiding structural building member 100 such that the cabling and wire guiding structural building member 100 clamps tightly to an engineered floor joist, a girder, or the like.

As noted above, one or more holes or apertures 200 are formed through the substantially flat surface 130. The apertures 200 are typically formed directly through the structural member 100, but may likewise be separately inserted into bodies made of the same or a different material as the structural member 100. The apertures 200 are typically formed such that they define a row of toroidal protuberances parallel to the longitudinal axis no. The apertures 200 are also typically located at predetermined longitudinal cabling distances in the substantially flat surface 13o. Longitudinal cabling distances are the locations along the longitudinal axis no that are predetermined to be potentially desirable for cabling. Typically, the longitudinal cabling distances are from about 5 inches to about 14 inches, from about 40 inches to about 53 inches, and from about 74 inches to about 86 inches from the end of the cabling and wire guiding structural building member 100. However, any convenient predetermined longitudinal cabling distances may likewise be implemented.

Each aperture 200 has a rolled surface 205 that extends in a toroidal protuberance that is perpendicular to the flat surface 130. In some implementations, the rolled surface 205 ends in a rounded edge terminus 210 to decrease the resistance of cable 207 moving therethrough and to enhance the resilience of the rolled surface 205. For example, the rounded edge terminus 210 implementation may be used in situations calling for the repeated cabling. Typically, aperture 200 includes a central, generally right circular hyperboloid shaped portion 201, at least one end of which, and more typically both ends of which, terminate in the rolled surface 205 extending through opposing flat surfaces 130 of structural member 100. Cable 207 extending therethrough may thus be moved through aperture 200 in either direction with low resistance and with minimal chance of snagging, de-sheathing, and damage.

In some implementations, the diameter of an aperture 200 can be sized to allow a specific gauge of cable 207 to be threaded through the aperture 200. For example, the design for a building could call for a maximum cable gage as a means to limit power and/or wattage. In this case, the cabling and wire guiding structural building member 100 is formed such that the aperture 200 permits the threading of cable 207 of a gage no greater than the maximum cable gage. In some implementations the rolled surface 205 is formed such that the rolled surface 205 can be selectively compressed to reduce the diameter of the aperture 200 to a predetermined cable gage. For example, the rolled surface 205 could be compressed such that a small bundle of wires or other cabling fit snugly through the aperture 200. Alternately, the rolled surface 205 could be expanded to allow larger gauges or a greater number of wires or cabling to be fed through the aperture 200. Additionally, in some implementations the aperture 200 is partially surrounded by a void 210 in the substantially flat surface 130, enabling the aperture 200 to be redirected. The partial void enables a portion of substantially flat surface 130 to be bent, redirecting the aperture 200 and the aperture's rolled surface 205. For example, an aperture 200 and the aperture's rolled surface 205 could be redirected to facilitate the threading of a cable 207 or even serve as a cable guide in a direction different from the original orientation of the aperture 200.

In some implementations, the substantially flat surface may have perforations 279 partially enclosing an aperture 200. In such implementations, the perforations 279 enable a portion of the flat planar surface 130 to be detached such that the detached portion of the flat surface 285 can be bent, redirecting the aperture 200. Redirecting the aperture 200 can allow the aperture 200 to thread 207 or wire in directions not enabled by not redirecting the aperture. This allows the aperture 200 to be adapted to the needs of the builder during the construction of the building structure 100. For example, the aperture 200 can be redirected to permit the threading of cable or wire 207 in directions parallel to the longitudinal direction of the substantially flat planar surface 130.

FIG. 3 is an illustration facing the concave side of a cabling and wire guiding structural building member 100. In some implementations, the apertures 200 are not fully formed but rather are defined as sectioned and perforated points 245. Typically, the sectioned and perforated points 245 are formed such that the underlying material is pre-stressed, such that upon punching, the sections curl into a rolled surface 205. In some implementations, the underlying material is pre-stressed and indented such that upon punching, the opening can be forcibly adjusted to predetermined sizes.

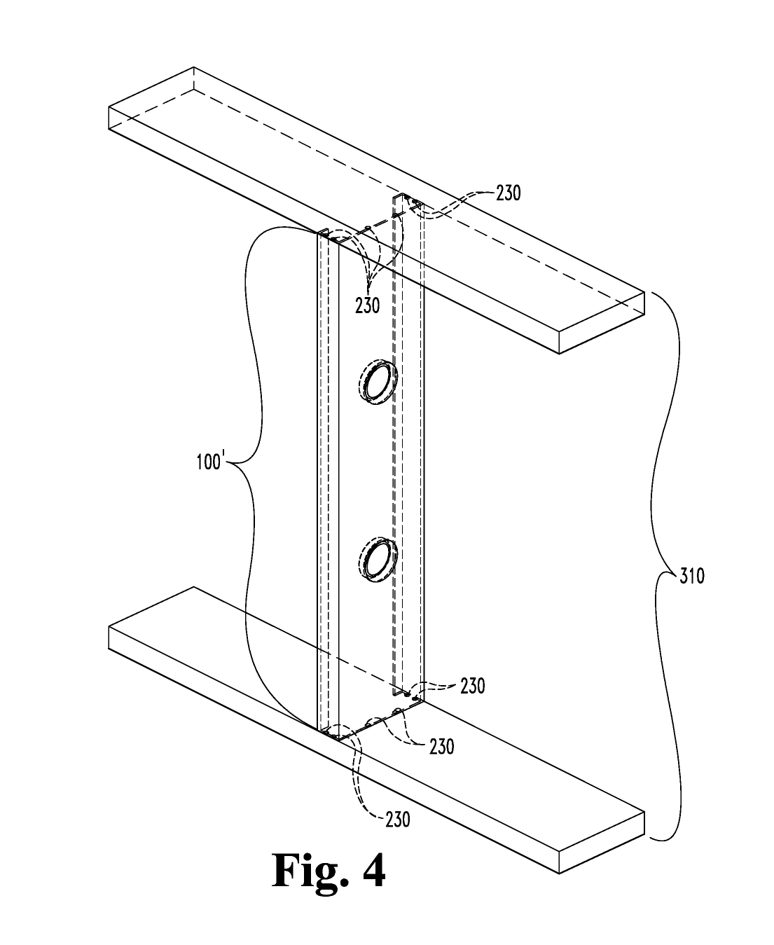

FIG. 4 is an illustration of an implementation of a cabling and wire guiding structural building member 100 fixably attached to another building device 310. In some implementations, the cabling and wire guiding structural building member 100 is shaped to include attachment points 230 such as tabs, nibs, extensions, or the like. In some implementations, the cabling and wire guiding structural building member 100 includes perforated sections that when punched, form the attachment points 230 such as tabs, nibs, extensions, or the like. In some implementations, the attachment points 230 are pre-stressed to enable them to mechanically clasp against the building device 310. In some implementations, the cabling and wire guiding structural building member 100 is shaped to include many attachment projections that are sharp and extend outward, permitting the cabling and wire guiding structural building member 100 to be attached to a building device 310 by a hammer. For example, the cabling and wire guiding structural building member 100 can be hammered into attachment with a floor joist.

In operation, the cabling and wire guiding structural building member 100 is positioned as desired. For example, the cabling and wire guiding structural building member 100 can be placed into the framework of a building. Alternatively, the cabling and wire guiding structural building member 100 can be secured to another building device 310. In some implementations, the attachment of the cabling and wire guiding structural building member 100 to another building device 310 is performed through using tabs, nibs, extensions, or the like to mechanically clasp another building device 310. Alternatively, the sharpened projections of some implementations enable the cabling and wire guiding structural building member 100 to be hammered into attachment with a second structural building member or device 310.

A cable 207 is then threaded through the cabling and wire guiding structural building member 100 via an aperture 200. A portion of the cable 207, or the entire cable length, may be retracted back through the aperture 200 without undue resistance, as the aperture 200 includes a rolled or rounded surface portion 205 extending from either side of the member 100. Alternatively, some implementations permit a portion of the cabling and wire guiding structural building member 100 to be extended or redirected. The extension or redirection enables the apertures 200 of the cabling and wire guiding structural building member 100 to be oriented such cabling can occur in directions that may not be oriented in the same direction as the cabling and wire guiding structural building member 100. For example, an aperture 200 can be oriented such that cabling is enabled in a direction parallel to the cabling and wire guiding structural building member 100.

During operation, the cable or elongated cylindrical workpiece 207 may move freely back and forth through the aperture 200, as may fluids; the aperture 200 remains unsealed relative the workpiece, such that fluids may freely flow though the aperture along with the workpiece. Fluidic communication through the aperture 200 is maintained around any cable 207 extending therethrough. In many implementations, aperture 200 is generally circular but at least slightly ovoid to facilitate cable 207 movement therethrough; in other implementations, the aperture 200 is noncircular.

Some implementations permit the creation of the apertures 200 to be done at the time of cabling. Such apertures 200 are created by punching out perforated sections 245. The perforated sections 245 are pre-stressed such that a rounded edge 205 automatically results from the punching out of a perforated section 245. A cable 207 may then be threaded through the resulting aperture 200.

Some implementations provide for cabling involving the use of certain size or smaller cables. Such implementations of the cabling and wire guiding structural building member 100 have apertures 200 sized to a specific diameter. The specific diameter of the apertures 200 only allow cables 207 of that diameter or smaller to be threaded through the apertures 200. Alternatively, the rolled surfaces 205 of apertures 200 of some implementations can be compressed, precluding larger cables 207 from being threaded through the apertures 200. Note that such rolled edges 205 can also be compressed against threaded cables 207, effectively locking a threaded cable 207 in the aperture 200 and preventing any further movement of the cable 207 through the aperture 200.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

We claim:

1. A cabling and wire guiding device comprising:
a structural member defining a first surface and a second, oppositely spaced and generally parallel second surface;
a generally toroidal aperture extending through the structural member and having a first end intersecting the first surface and an oppositely disposed second end intersecting the second surface;
a first rounded end portion connecting the first end to the first surface;
a second rounded end portion connecting the second end to the second surface; and
an elongated cylindrical workpiece extending through the aperture;
wherein the elongated cylindrical workpiece may freely move back and forth through the aperture;
wherein the aperture remains unsealed to the workpiece;
wherein the aperture is at least slightly ovoid; and
wherein fluid flow though the aperture is maintained and uninterrupted by the elongated cylindrical workpiece.

2. The device of claim 1 and further comprising a plurality of perforations formed through structural member and positioned around the aperture.

3. The device of claim 1 wherein each respective rounded end portion protrudes beyond the respective surface to define respective generally toroidal protuberances for guiding cable therethrough.

4. A guiding device comprising:
an elongated structural member having a first surface and a second spaced, generally parallel surface;
a cylindrical aperture extending through the elongated structural member and having a rounded raised first end engaging the first surface and an oppositely disposed rounded raised second end engaging the second surface;
wherein a cable may rollingly engage either rounded end and freely move through the aperture; and
wherein fluidic communication is maintained around the cable extending through the cylindrical aperture.

5. A structural building cable and wire guiding device, comprising:
a structural member defining a substantially flat first surface extending along a longitudinal axis;
at least one generally toroidal aperture extending generally perpendicularly from the first surface, comprising:
a first end portion connecting the at least one toroidal aperture to the first surface; and
a second, oppositely disposed end portion that is free to deform;
wherein flexure an end portion of the at least one toroidal aperture allows cables to pass back and forth therethrough;
wherein the at least one aperture further comprises a rolling surface for orienting the aperture.

6. The system of claim 5 wherein the diameter of the at least one toroidal aperture is slightly ovoid.

7. The system of claim 5 wherein the diameter of the at least one toroidal aperture is noncircular.
